(19) United States
(12) Patent Application Publication
(10) Pub. No.: US 2026/0145181 A1
(43) Pub. Date: May 28, 2026

(54) VORTEX TUBE ASSEMBLY

(71) Applicant: Airbus Operations Limited, FILTON (GB)

(72) Inventor: Henry EDWARDS, FILTON (GB)

(21) Appl. No.: 19/388,353

(22) Filed: Nov. 13, 2025

(30) Foreign Application Priority Data
Nov. 28, 2024 (GB) 2417510.1

(51) Int. Cl. B04C 3/06; B04C 3/00; B04C 11/00; B64D 37/32

(52) U.S. Cl. CPC B04C 3/06; B04C 11/00; B64D 37/32; B04C 2003/006

(57) ABSTRACT

A vortex tube assembly for an aircraft enclosure inerting system has a plenum chamber and a swirl generator which has an inlet passage that allows air in the plenum chamber to enter a vortex chamber whereupon the air can be centrifugally separated into nitrogen enriched air (NEA) and oxygen enriched air (OEA). A throttle pin is positioned within the inlet passage, an outer surface of the throttle pin and an inner surface of the inlet passage co-operatively defining a flow path for air to enter the vortex chamber from the plenum chamber. The throttle pin is movable between a restrictive position and a permissive position, with the flow path being more constricted when the throttle pin is in the restrictive position than when the throttle pin is in the permissive position. The throttle pin is biased to the permissive position and movable to the restrictive position against this bias.

### CROSS-REFERENCES TO RELATED APPLICATIONS

This application claims the benefit of United Kingdom Patent Application Number 2417510.1 filed on Nov. 28, 2024, the entire disclosures of which are incorporated herein by way of reference.

### FIELD OF THE INVENTION

The present disclosure relates to the field of vortex tubes for aircraft enclosure inerting systems. It relates particularly, but not exclusively, to vortex tube assemblies for inerting systems which can be used to fill the ullage of an aircraft fuel tank with nitrogen enriched air as a fire safety precaution.

### BACKGROUND OF THE INVENTION

Owing to airworthiness requirements, most commercial aircraft require the use of fuel tank inerting systems among a suite of other measures to prevent aircraft fuel tank fires or explosions. The primary purpose of such inerting systems (also referred to as inert gas generation systems) is to reduce the oxygen O concentration within the aircraft fuel tank ullage, and hence the ullage flammability, thereby preventing the ability of the ullage to combust. State of the art systems comprise the use of one or more Air Separation Modules (ASMs) to separate bleed air into nitrogen enriched air (NEA), sometimes called oxygen depleted air, and oxygen enriched air (OEA). The OEA is exhausted overboard from the aircraft whilst the NEA is fed in a controlled manner at predetermined rates into the ullage above the fuel in the aircraft's fuel tank or tanks such that the O₂ concentration of the ullage is kept below an upper limit (for instance 12%) during most operating conditions of the aircraft.

In conventional systems bleed air, which is high temperature and pressure bled from an engine or from a separate compressor fed by a ram air channel, is filtered and cooled before being inputted into the ASM(s). Cooling and filtering of the bleed air is important because the ASM contains a membrane, often in the form of a set of hollow fibers, over which the input air passes. The membrane can be clogged if the input air contains contaminants like dust, and degrades too rapidly if subjected to input air above a certain temperature. The membrane of the/each ASM is permeable to oxygen but not to nitrogen, so as the air passes over the membrane much of the oxygen it contains passes through the membrane while the nitrogen continues along it. This separates the air into the NEA and OEA. The NEA can then be regulated into the ullage, while the OEA can be discarded as mentioned.

One problem with conventional inerting systems is that ASMs also often have relatively short service life in comparison to that of an aircraft. As mentioned, ASMs can be damaged if their intake air is too hot, or operated in environments where the air contains high levels of contaminants such as dust or ash. Therefore, filtering and cooling is necessary which results in further weight, bulk and expense, and the presence of the cooling apparatus also reduces air flow rate. Also, the membranes of NEAs degrade over their service life even if not subject to excessive heat or contaminants, therefore the/each NEA must be over-sized so that membrane degradation does not bring its performance below the required level.

An alternative way of producing NEA is through use of a vortex tube. A vortex tube has a chamber into which air is formed into vortex. As the air rotates inside the chamber it produces a hotter stream around the outside and a colder stream towards the middle. Vortex tubes are generally used to provide cooling rather than air separation. However, oxygen, being denser than nitrogen, tends to be thrown out into the outer stream, leaving the inner stream in a nitrogen enriched state.

Generally speaking there is a trade-off between separation efficiency (i.e., reduction in the O₂ concentration in the NEA) and throughput (i.e., flow rate of NEA produced). For a given flow rate into it, the separation performance of a vortex tube (i.e., the compromise between separation efficiency and throughput) is dependent on the behavior of the air inside it, which is dependent on its geometry. Conventional vortex tubes have a fixed geometry, therefore offer one specific level of separation performance. Depending on its geometry a vortex tube may offer particularly high separation efficiency (i.e., may output NEA with particularly low levels of oxygen) at the expense of flow rate, may offer particularly high flow rates of NEA at the expense of separation efficiency, or may offer a particular compromise between the two. Thus, each vortex tube is tailored to a specific set of circumstances.

Some vortex tubes have a plenum chamber surrounding part of the vortex chamber into which air is fed. A swirl generator positioned inside the plenum chamber has one or more flow paths which allow air from the plenum chamber to enter the vortex chamber (often tangentially so as to maximize the swirl of air within the vortex chamber). Some of these vortex tubes are supplied with a set of interchangeable swirl generators of different geometries. This allows the end user to select the geometry of swirl generator which will produce the most suitable separation performance (i.e., the best compromise between flow rate and separation efficiency for a particular application). However, once the swirl generator has been selected that vortex tube will, again, offer specific and unchangeable separation performance.

In conventional aircraft enclosure inerting systems it is sometimes desirable for the same apparatus to offer different separation performance at different times, for instance where the aircraft enclosure is the fuel tank ullage. During aircraft climb and cruise it may be desirable to provide NEA at high purity and lower flow rate, to compensate for the reduction in ambient pressure sucking inert gas out of the fuel tank through a vent (during climb) and then to ensure that ambient air does not diffuse through the vent (during cruise). During approach and normal descent it may be desirable to provide NEA at a higher flow rate (and thus lower purity) to counteract the steady increase in ambient pressure which could otherwise force ambient air into the ullage through the vent. During normal descent it may be desirable to provide NEA at an even higher flow rate (and thus lower purity) so as to counteract the more rapid increase in pressure.

In conventional aircraft enclosure inerting systems, the different separation performance requirements are fulfilled by using several ASMs connected in parallel, each with an isolation valve. Air is passed through different numbers of the ASMs according to the requirement of the system as a whole.

While it would hypothetically be possible to produce a vortex tube, the geometry of which can be actively controlled, malfunction of the control system may cause such a vortex tube to move to or become stuck in a configuration in which insufficient NEA can be generated by the vortex tube. Accounting for the possibility of such a failure would normally require heavy, bulky and/or expensive measures to be taken (for instance the provision of a backup control system and/or a backup vortex tube).

A further problem with vortex tubes is that they can suffer from clogging with dirt and/or ice during use. Even partial clogging of a vortex tube affects the air flow inside it, negatively affecting performance. To combat this possibility, vortex tubes in many applications require filtration and/or air-drying apparatus upstream of them. Such apparatus can be quite costly, however, and, particularly in the context of aircraft inerting systems, the added weight and bulk of such apparatus is particularly detrimental.

The present invention seeks to mitigate one or more of the above-mentioned problems. Alternatively or additionally, the present invention seeks to provide an improved or alternative vortex tube assembly, aircraft enclosure inerting system, aircraft, or method of controlling separation of an inlet air flow into an NEA flow and an OEA flow using a vortex tube assembly.

### SUMMARY OF THE INVENTION

According to a first aspect of the present invention there is provided a vortex tube assembly for centrifugally separating an inlet air flow into a nitrogen-enriched air (NEA) flow and an oxygen-enriched air (OEA) flow in an aircraft enclosure inerting system, the vortex tube assembly comprising:
a plenum chamber configured to receive the inlet air flow;
a vortex chamber configured for centrifugal separation of the inlet air flow into the NEA flow and the OEA flow;
a swirl generator having an inlet passage which provides fluid communication between the plenum chamber and the vortex chamber; and
a throttle pin positioned within the inlet passage, an outer surface of the throttle pin and an inner surface of the inlet passage co-operatively defining a flow path for air to enter the vortex chamber from the plenum chamber, wherein:
the throttle pin is selectively movable relative to the inlet passage between a restrictive position and a permissive position, the flow path being more constricted when the throttle pin is in the restrictive position than when the throttle pin is in the permissive position; and
the throttle pin is biased to the permissive position and movable to the restrictive position against this bias.

Movement of the throttle pin may act to dislodge accumulated dirt and/or ice, which may make the vortex tube assembly less vulnerable to clogging and thus less reliant on filtration and/or air drying systems. Also, the throttle pin being movable can allow the behavior or the vortex tube assembly (for instance its separation performance) to be adjusted to suit different requirements at different times.

The throttle pin being biased to the permissive position may act as a failsafe feature. In the event of a fault in a system responsible for moving the throttle pin or a loss of power to that system, the throttle pin may move to the permissive position so as to ensure that sufficient air can still flow through the vortex tube assembly. This may be at the expense of a reduction in purity of the NEA, but in many contexts it is more important that sufficient NEA is produced and some reduction in purity may be tolerable. With a vortex tube assembly that is more tolerant of such faults, there may be less need for backup equipment such as a backup throttle pin movement system or a backup vortex tube assembly.

Referenced to the throttle pin being provided within the inlet passage should not be interpreted to mean that all of the throttle pin must necessarily be receivable in the flow path, or that all of the flow path must be able to receive part of the throttle pin. Rather, it should be interpreted to mean that part of the throttle pin must be receivable in part of the flow path.

The term “throttle pin” is used to imply an elongate component. It should not be interpreted as requiring the component to have a pointed tip or be circular in cross section.

At least part of the flow path may be annular in cross section.

This may make the flow path less vulnerable to blockage, since to block that part it would be necessary for dirt/ice to accumulate all around its circumference.

Such a flow path may be annular in cross section along its entire length regardless of the position of the throttle pin. As an alternative, it may have a part which is not annular regardless of the position of the throttle pin. As another alternative, it may be annular in cross section along its entire length when the throttle pin is in one position, and have a part which is not annular when the throttle pin is in a different position.

As an alternative, the flow path might not have any part which is annular in cross section. For instance, the throttle pin may be wedge-shaped and positioned on one side of an inlet passage which is square in cross-section, defining a flow path which is rectangular in cross section.

The inlet passage may extend along a longitudinal axis and the throttle pin may be movable along the axis between the restrictive and permissive positions.

This may allow the flow of air along the flow path to be beneficially smooth regardless of the position of the throttle pin. In contrast, in an arrangement where the throttle pin moved in a direction at an angle to the longitudinal axis of the inlet passage, movement of the throttle pin may change the cross sectional shape of the flow path. This, in turn, may have a detrimental effect on the flow of air therethrough.

At least part of the inlet passage may narrow towards the vortex chamber.

This may have the effect of accelerating the flow of air through the flow path, which in turn may increase the swirl of air in the vortex chamber and improve performance. Instead or as well, it may allow for a beneficially straightforward manner in which movement of the throttle pin can affect the constriction of the flow path—moving a tip portion of the throttle pin deeper into the narrowed end having the effect of constricting the flow path more, and retracting the throttle pin having the effect of widening the flow path.

Substantially the entire inlet passage may narrow towards the vortex chamber. For example, the inlet passage may be substantially conical, trumpet-shaped or bullet-shaped (or a combination thereof).

At least part of the throttle pin may narrow towards the vortex chamber.

This may allow for a beneficially straightforward manner in which movement of the throttle pin can affect the constriction of the flow path—moving the tapered part towards (e.g.) a mouth of inlet passage having the effect of constricting the flow path more, and retracting the throttle pin having the effect of widening the flow path. Instead or as well, the narrowing portion of the throttle pin may act to smooth the flow of air through the flow path.

This part may be the tip portion of the throttle pin.

As an alternative to the throttle pin having at least a part that narrows towards the vortex chamber, the throttle pin may not taper, or may even widen towards the vortex chamber.

The throttle pin may be biased to the permissive position by a resilient member.

This may be a beneficially robust, simple (e.g., to use or to service) and/or cheap way of biasing the throttle pin. The resilient member may be, for example, an elastomeric component or a spring such as a coil spring or a gas spring.

As an alternative (or in addition to a resilient member), the throttle pin may be biased by a magnet and/or may be biased by a stream of gas continually “blowing” the throttle pin towards the permissive position.

The throttle pin may have a position in which the flow path is substantially closed.

That position may be the restrictive position, or may be a position more restrictive than the restrictive position (for instance the restrictive position may lie between the permissive position and the position in which the flow path is substantially closed).

The throttle pin having a position in which the flow path is substantially closed may allow the vortex tube assembly to be shut down, for instance when not needed or if it is malfunctioning, without the need for a separate shutdown system (which may increase the complexity, cost, weight and/or bulk of the apparatus as a whole).

As an alternative the range of motion of the throttle pin, and/or the shapes of the throttle pin and inlet passage, may be such that some air can flow through the flow path regardless of the position of the throttle pin.

The vortex tube assembly may further comprise a controller and an actuator which is operable by the controller to move the throttle pin between positions.

As an alternative, the throttle pin may be configured for manual adjustment, e.g., using a screw thread or adjustment via an actuator which is manually controlled.

The actuator may be a solenoid, an electric linear actuator, a pneumatic or hydraulic cylinder, a wax motor, or any other suitable actuator such as an electric motor or hydraulic motor which acts on the throttle pin via a rack and pinion.

Optionally:
the throttle pin is also movable to one or more intermediate positions, that lie between the restrictive position and the permissive position, in which the flow path is less constricted than when the throttle pin is in the restrictive position but more constricted than when the throttle pin is in the permissive position; and
the controller is configured to move the throttle pin, using the actuator, between two or more positions so as to adjust the performance of the vortex tube assembly.

These two or more positions may include the restrictive position and the permissive position, or may include one or more intermediate positions and either the restrictive position or the permissive position, or may include two or more intermediate positions and neither the restrictive position nor the permissive position.

The controller may be configured to move the throttle pin between the two or more positions so as to adaptively maintain an output parameter of the vortex tube assembly at a target level.

Thus, the vortex tube assembly may be able to continue to supply NEA (or OEA in applications outside of aircraft enclosure inerting) at the required purity and throughput even if the properties of the inlet air flow (such as temperature and/or flow rate) fluctuate during use.

This output parameter may be an oxygen concentration of the NEA flow or the OEA flow, or a flow rate of the NEA flow or the OEA flow.

The controller may be configured to move the throttle pin between positions so as to switch between different discrete modes of the vortex tube assembly.

It is to be understood that this may be instead of or as well as the controller being configured to adaptively maintain an output parameter of the vortex tube assembly at a target level. Where the controller is configured both to adaptively maintain an output parameter of the vortex tube assembly at a target level and also to switch between different discrete modes of the vortex tube assembly, the controller may be configured to adaptively maintain an output parameter of the vortex tube assembly at a target level when the vortex tube in one discrete mode, or in two or more discrete modes (for instance all modes) of the vortex tube assembly.

Optionally:
the discrete modes include a first mode and a second mode;
the oxygen concentration of the NEA flow is lower when the vortex tube assembly is in the first mode than when it is in the second mode; and
the flow rate of the NEA flow is lower when the vortex tube assembly is in the first mode than when it is in the second mode.

As an alternative, the discrete modes may be an operational mode and a shut-down mode in which no air can flow through the vortex tube assembly.

The controller may be configured to receive a signal indicative of the flow path being obstructed, and respond by moving the throttle pin to another position and back so as to clear the obstruction.

With it being able to clear obstructions in this way, the vortex tube assembly may be less reliant on filtration and/or air drying systems, allowing simpler and/or smaller ones to be used and thereby reducing the overall expense, complexity, weight and/or bulk of the system as a whole. Indeed, such a vortex tube assembly may even be able to operate without any filtration or air drying systems.

The controller may receive the signal from, for example, a sensor such as a pressure sensor, flow rate sensor, oxygen sensor or temperature sensor, which may be positioned in the inlet air flow, the NEA flow or the OEA flow. The controller may receive signals from more than one such sensor. The controller may be configured to perform calculations based on the signal(s) from the sensor(s), alone or in combination with other data, to deduce whether or not the flow path is obstructed.

As an alternative to the controller receiving a signal from one or more sensors, a separate monitoring unit may receive signals from one or more sensors and the controller may then receive a command signal, indicating that the flow path is obstructed, from the monitoring unit.

The controller may be configured to move the throttle pin to another position and back in less than a minute, for instance less than 30 seconds or less than 10 seconds. This may reduce the amount of time for which the throttle pin is in a position that is different to the desired position, thereby reducing the impact of the obstruction clearing process on the separation performance of the vortex tube assembly.

The controller may be configured to respond to the signal by moving the throttle pin to the permissive position and back, thereby temporarily widening the flow path.

Temporarily widening the flow path may make it wide enough to allow the obstruction to pass through it.

Alternatively, the controller may be configured to respond to the signal by moving the throttle pin to the restrictive position and back, thereby temporarily constricting the flow path. This may have the effect of crushing or breaking up the obstruction, into pieces which are small enough to pass through the flow path (for instance when the throttle pin has returned its original position).

The swirl generator may comprise one or more additional inlet passages, the, or each, additional inlet passage providing fluid communication between the plenum chamber and the vortex chamber.

The presence of more than one inlet passage in the swirl generator may allow air to enter the vortex chamber more evenly, which may improve the swirl within the vortex chamber and improve separation.

The inlet passage and the additional inlet passage(s) may be spaced apart from one another substantially evenly about a circumference of the vortex chamber. This may further increase the evenness of air entering the vortex chamber.

Optionally:
each additional inlet passage has a corresponding additional throttle pin positioned within it, an outer surface of the additional throttle pin and an inner surface of the additional inlet passage co-operatively defining an additional flow path for air to enter the vortex chamber from the plenum chamber; and
each additional throttle pin is selectively movable relative to the corresponding additional inlet passage between a restrictive position and a permissive position, the corresponding additional flow path being more constricted when the additional throttle pin is in the restrictive position than when the additional throttle pin is in the permissive position.

Movement of the additional throttle pin(s) may act to dislodge accumulated dirt and/or ice in the additional inlet passage(s), which may make the vortex tube assembly less vulnerable to clogging and thus less reliant on filtration and air drying systems. Also, the additional throttle pin(s) being movable can allow the behavior or the vortex tube assembly (for instance its separation performance) to be adjusted to a greater extent than if only the inlet passage had a movable throttle pin. Furthermore, making adjustments to the constriction of all inlet passages together may allow air to enter the vortex chamber more uniformly, which may boost performance.

Where the vortex tube assembly has a controller and actuator as described above, the additional throttle pins may be moved by the same controller (either using the same actuator or using separate actuators). As an alternative, the, or each, additional throttle pin may have its own controller and its own actuator.

Each additional throttle pin may be biased to the permissive position and movable to the restrictive position against this bias.

This may allow the failsafe functionality discussed above to be applicable to the additional inlet passage(s) as well, which may allow the vortex tube assembly to supply sufficient NEA in the event of a fault in a system responsible for moving the additional throttle pin(s), and/or may allow sufficient NEA to be supplied in the case of a fault with a system responsible for moving all the throttle pins (whereas this may not be possible if only the inlet passage had a failsafe).

The additional inlet passage(s) may be substantially the same as the inlet passage. Instead or as well, the additional throttle pin(s) may be substantially the same as the throttle pin.

According to a second aspect of the present invention there is provided an aircraft enclosure inerting system comprising a vortex tube assembly according to the first aspect of the invention.

Such a system may be less reliant on, or have no need of, filtration and air drying systems for the reasons given above. Instead or as well, such a system may be more capable of supplying sufficient NEA in the case of a fault without as much need for backup equipment, for the reasons discussed above.

The inerting system may further comprise one or more additional vortex tubes. The vortex tube according to the first aspect of the invention and the additional vortex tube(s) may be connected in series (with the NEA produced by the most upstream vortex tube being further refined by the vortex tube(s) downstream of it) or in parallel (with each vortex tube receiving a portion of the inlet air flow and producing a portion of the NEA and OEA).

According to a third aspect of the present invention there is provided an aircraft comprising an aircraft enclosure inerting system according to the second aspect of the invention.

Such an aircraft may be less reliant on, or have no need of, filtration and air drying systems for its enclosure inerting system, and/or may have a more reliable supply of NEA with less need for backup equipment, for one or more of the reasons discussed above.

According to a fourth aspect of the present invention there is provided a method of controlling separation of an inlet air flow into a nitrogen-enriched air (NEA) flow and an oxygen-enriched air (OEA) flow using a vortex tube assembly which comprises:
a plenum chamber configured to receive the inlet air flow;
a vortex chamber configured for centrifugal separation of the inlet air flow into the NEA flow and the OEA flow;
a swirl generator having an inlet passage which provides fluid communication between the plenum chamber and the vortex chamber; and
a throttle pin positioned within the inlet passage, an outer surface of the throttle pin and an inner surface of the inlet passage co-operatively defining a flow path for air to enter the vortex chamber from the plenum chamber,
wherein the throttle pin is selectively movable relative to the inlet passage between a restrictive position and a permissive position, the flow path being more constricted when the throttle pin is in the restrictive position than when the throttle pin is in the permissive position, wherein the method comprises:
operating the vortex tube assembly with the throttle pin in one of the positions; then
in response to a signal indicative of the flow path being obstructed, moving the throttle pin to the other of the positions and then back so as to clear the obstruction; then
continuing operation of the vortex tube assembly with the throttle pin in the one of the positions.

By clearing obstructions in this way, there may be less need for filtration and/or air drying systems in corresponding fashion to that discussed above.

This one of the positions may be the restrictive position, whereupon the other of the positions may be the permissive position. Thus, the flow path may be temporarily widened so as to allow an obstruction to pass through it, before being returned to the desired size. As an alternative, the one of the positions may be the permissive position, whereupon the other of the positions may be the restrictive position. Thus, the flow path may be temporarily narrowed so as to compress or break up an obstruction, before being returned to the desired size (whereupon the broken-up or compressed obstruction may pass through it if it had not already done so).

Optionally:
the throttle pin is also movable to one or more intermediate positions, which lie between the restrictive position and the permissive position, in which the flow path is less constricted than when the throttle pin is in the restrictive position but more constricted than when the throttle pin is in the permissive position; and
the step of operating the vortex tube assembly and/or the step of continuing operation of the vortex tube assembly comprises moving the throttle pin between two or more positions so as to adjust the performance of the vortex tube assembly.

The throttle pin may be moved between the two or more positions so as to adaptively maintain an output parameter of the vortex tube assembly, for instance an oxygen concentration of the NEA flow or the OEA flow, or a flow rate of the NEA flow or the OEA flow, at a target level.

The step of operating the vortex tube assembly and/or the step of continuing operation of the vortex tube assembly may comprise moving the throttle pin between positions so as to switch between different discrete modes of the vortex tube assembly.

Optionally:
the discrete modes include a first mode and a second mode;
the oxygen concentration of the NEA is lower when the vortex tube assembly is in the first mode than when it is in the second mode; and
the flow rate of the NEA is lower when the vortex tube assembly is in the first mode than when it is in the second mode.

Optionally:
the swirl generator comprises one or more additional inlet passages, the, or each, additional inlet passage providing fluid communication between the plenum chamber and the vortex chamber;
each additional inlet passage has a corresponding additional throttle pin positioned within it, an outer surface of the additional throttle pin and an inner surface of the additional inlet passage co-operatively defining an additional flow path for air to enter the vortex chamber from the plenum chamber;
each additional throttle pin is selectively movable relative to the corresponding additional inlet passage between a restrictive position and a permissive position, the corresponding additional flow path being more constricted when the additional throttle pin is in the restrictive position than when the additional throttle pin is in the permissive position;
while the vortex tube assembly is operated with the throttle pin in one of the positions, each additional throttle pin is in a corresponding one of the positions; and
in response to a signal indicative of the flow path being obstructed, each additional throttle pin is moved to a corresponding other of the positions and then back.

All the throttle pins (i.e., the throttle pin and the, or each, additional throttle pin) may be moved to their respective positions and back at the same time as one another. As an alternative, all the throttle pins may be moved sequentially.

The vortex tube assembly of the fourth aspect of the invention may be a vortex tube assembly according to the first aspect of the invention.

According to a fifth aspect of the present invention there is provided a vortex tube assembly for centrifugally separating an inlet air flow into a nitrogen-enriched air (NEA) flow and an oxygen-enriched air (OEA) flow in an aircraft enclosure inerting system, the vortex tube assembly comprising:
a plenum chamber configured to receive the inlet air flow;
a vortex chamber configured to centrifugally separate the inlet air flow into the NEA flow and the OEA flow;
a swirl generator having an inlet passage which provides fluid communication between the plenum chamber and the vortex chamber;
a throttle pin positioned within the inlet passage, an outer surface of the throttle pin and an inner surface of the inlet passage co-operatively defining a flow path for air to enter the vortex chamber from the plenum chamber; and
a controller and an actuator which is operable by the controller, wherein:
the throttle pin is selectively movable relative to the inlet passage, by the actuator under control of the controller, between a restrictive position and a permissive position, the flow path being more constricted when the throttle pin is in the restrictive position than when the throttle pin is in the permissive position; and
the controller is configured to receive a signal indicative of the flow path being obstructed, and respond by moving the throttle pin from one of the positions to the other of the positions and back so as to clear the obstruction.

By being able to clear obstructions in this way, the vortex tube assembly may have less need for filtration and/or air drying systems in corresponding fashion to that discussed above.

The controller may be configured to respond to the signal by moving the throttle pin to the permissive position and back, thereby temporarily widening the flow path.

Temporarily widening the flow path may make it wide enough to allow the obstruction to pass through it.

Alternatively, the controller may be configured to respond to the signal by moving the throttle pin to the restrictive position and back, thereby temporarily constricting the flow path. This may have the effect of crushing or breaking up the obstruction, into pieces which are small enough to pass through the flow path (for instance when the throttle pin has returned its original position).

The throttle pin may be biased to the permissive position and movable to the restrictive position against this bias.

The throttle pin being biased to the permissive position may act as a failsafe feature. In the event of a fault in a system responsible for moving the throttle pin, or a loss of power to that system, the throttle pin may move to the permissive position so as to ensure that sufficient air can still flow through the vortex tube assembly. This may be at the expense of a reduction in purity of the NEA, but in many contexts it is more important that sufficient NEA is produced and some reduction in purity may be tolerable. With a vortex tube assembly that is more tolerant of such faults, there may be less need for backup equipment such as a backup throttle pin movement system or a backup vortex tube assembly.

At least part of the flow path may be annular in cross section.

This may make the flow path less vulnerable to blockage, since to block that part it would be necessary for dirt/ice to accumulate all around its circumference.

Such a flow path may be annular in cross section along its entire length regardless of the position of the throttle pin. As an alternative, it may have a part which is not annular regardless of the position of the throttle pin. As another alternative, it may be annular in cross section along its entire length when the throttle pin is in one position, and have a part which is not annular when the throttle pin is in a different position.

As an alternative, the flow path may not have any part which is annular in cross section. For instance, the throttle pin may be wedge-shaped and positioned on one side of an inlet passage which is square in cross-section, defining a flow path which is rectangular in cross section.

The inlet passage may extend along a longitudinal axis and the throttle pin may be movable along the axis between the restrictive and permissive positions.

This may allow the flow of air along the flow path to be beneficially smooth regardless of the position of the throttle pin. In contrast, in an arrangement where the throttle pin moved in a direction at an angle to the longitudinal axis of the inlet passage, movement of the throttle pin may change the cross sectional shape of the flow path. This, in turn, may have a detrimental effect on the flow of air therethrough.

At least part of the inlet passage may narrow towards the vortex chamber.

This may have the effect of accelerating the flow of air through the flow path, which in turn may increase the swirl of air in the vortex chamber and improve performance. Instead or as well, it may allow for a beneficially straightforward manner in which movement of the throttle pin can affect the constriction of the flow path—moving a tip portion of the throttle pin deeper into the narrowed end having the effect of constricting the flow path more, and retracting the throttle pin having the effect of widening the flow path.

Substantially the entire inlet passage may narrow towards the vortex chamber. For example, the inlet passage may be substantially conical, trumpet-shaped or bullet-shaped (or a combination thereof).

At least part of the throttle pin may narrow towards the vortex chamber.

This may allow for a beneficially straightforward manner in which movement of the throttle pin can affect the constriction of the flow path—moving the tapered part towards (e.g.) a mouth of inlet passage having the effect of constricting the flow path more, and retracting the throttle pin having the effect of widening the flow path. Instead or as well, the narrowing portion of the throttle pin may act to smooth the flow of air through the flow path.

This part may be a tip portion of the throttle pin.

As an alternative to the throttle pin having at least a part that narrows towards the vortex chamber, the throttle pin may not taper, or may even widen towards the vortex chamber.

The throttle pin may be biased to the permissive position by a resilient member.

This may be a beneficially robust, simple (e.g., to use or to service) and/or cheap way of biasing the throttle pin. The resilient member may be, for example, an elastomeric component or a spring such as a coil spring or a gas spring.

As an alternative (or in addition to a resilient member), the throttle pin may be biased by a magnet and/or may be biased by a stream of gas continually “blowing” the throttle pin towards the permissive position.

The throttle pin may have a position in which the flow path is substantially closed.

That position may be the restrictive position, or may be a position more restrictive than the restrictive position (for instance the restrictive position may lie between the permissive position and the position in which the flow path is substantially closed).

The throttle pin having a position in which the flow path is substantially closed may allow the vortex tube assembly to be shut down, for instance when not needed or if it is malfunctioning, without the need for a separate shutdown system (which may increase the complexity, cost, weight and/or bulk of the apparatus as a whole).

As an alternative the range of motion of the throttle pin, and/or the shapes of the throttle pin and inlet passage, may be such that some air can flow through the flow path regardless of the position of the throttle pin.

The vortex tube assembly may further comprise a controller and an actuator which is operable by the controller to move the throttle pin between positions.

As an alternative, the throttle pin may be configured for manual adjustment, e.g., using a screw thread or adjustment via an actuator which is manually controlled.

The actuator may be a solenoid, an electric linear actuator, a pneumatic or hydraulic cylinder, a wax motor, or any other suitable actuator such as an electric motor or hydraulic motor which acts on the throttle pin via a rack and pinion.

Optionally:
the throttle pin is also movable to one or more intermediate positions, that lie between the restrictive position and the permissive position, in which the flow path is less constricted than when the throttle pin is in the restrictive position but more constricted than when the throttle pin is in the permissive position; and
the controller is configured to move the throttle pin, using the actuator, between two or more positions so as to adjust the performance of the vortex tube assembly.

These two or more positions may include the restrictive position and the permissive position, or may include one or more intermediate positions and either the restrictive position or the permissive position, or may include two or more intermediate positions and neither the restrictive position nor the permissive position.

The controller may be configured to move the throttle pin between the two or more positions so as to adaptively maintain an output parameter of the vortex tube assembly at a target level.

Thus, the vortex tube assembly may be able to continue to supply NEA (or OEA in applications outside of aircraft enclosure inerting) at the required purity and throughput even if the properties of the inlet air flow (such as temperature and/or flow rate) fluctuate during use.

This output parameter may be an oxygen concentration of the NEA flow or the OEA flow, or a flow rate of the NEA flow or the OEA flow.

The controller may be configured to move the throttle pin between positions so as to switch between different discrete modes of the vortex tube assembly.

It is to be understood that this may be instead of, or as well as, the controller being configured to adaptively maintain an output parameter of the vortex tube assembly at a target level. Where the controller is configured both to adaptively maintain an output parameter of the vortex tube assembly at a target level and also to switch between different discrete modes of the vortex tube assembly, the controller may be configured to adaptively maintain an output parameter of the vortex tube assembly at a target level when the vortex tube in one discrete mode, or in two or more discrete modes (for instance all modes) of the vortex tube assembly.

Optionally:
the discrete modes include a first mode and a second mode;
the oxygen concentration of the NEA flow is lower when the vortex tube assembly is in the first mode than when it is in the second mode; and
the flow rate of the NEA flow is lower when the vortex tube assembly is in the first mode than when it is in the second mode.

As an alternative, the discrete modes may be an operational mode and a shut-down mode in which no air can flow through the vortex tube assembly.

The swirl generator may comprise one or more additional inlet passages, the, or each, additional inlet passage providing fluid communication between the plenum chamber and the vortex chamber.

The presence of more than one inlet passage in the swirl generator may allow air to enter the vortex chamber more evenly, which may improve the swirl within the vortex chamber and improve separation.

The inlet passage and the additional inlet passage(s) may be spaced apart from one another substantially evenly about a circumference of the vortex chamber. This may further increase the evenness of air entering the vortex chamber.

Optionally:
each additional inlet passage has a corresponding additional throttle pin positioned within it, an outer surface of the additional throttle pin and an inner surface of the additional inlet passage co-operatively defining an additional flow path for air to enter the vortex chamber from the plenum chamber; and
each additional throttle pin is selectively movable relative to the corresponding additional inlet passage between a restrictive position and a permissive position, the corresponding additional flow path being more constricted when the additional throttle pin is in the restrictive position than when the additional throttle pin is in the permissive position.

Movement of the additional throttle pin(s) may act to dislodge accumulated dirt and/or ice in the additional inlet passage(s), which may make the vortex tube assembly less vulnerable to clogging and thus less reliant on filtration and air drying systems. Also, the additional throttle pin(s) being movable can allow the behavior or the vortex tube assembly (for instance its separation performance) to be adjusted to a greater extent than if only the inlet passage had a movable throttle pin. Furthermore, making adjustments to the constriction of all inlet passages together may allow air to enter the vortex chamber more uniformly, which may boost performance.

The controller may be configured to also respond to the signal indicative of the flow path being obstructed by moving each additional throttle pin from one of the positions to the other of the positions and back.

Where the vortex tube assembly has a controller and actuator as described above, the additional throttle pins may be moved by the same controller (either using the same actuator or using separate actuators). As an alternative, the, or each, additional throttle pin may have its own controller and its own actuator.

Each additional throttle pin may be biased to the permissive position and movable to the restrictive position against this bias.

This may allow the failsafe functionality discussed above to be applicable to the additional inlet passage(s) as well, which may allow the vortex tube assembly to supply sufficient NEA in the event of a fault in a system responsible for moving the additional throttle pin(s), and/or may allow sufficient NEA to be supplied in the case of a fault with a system responsible for moving all the throttle pins (whereas this may not be possible if only the inlet passage had a failsafe).

The additional inlet passage(s) may be substantially the same as the inlet passage. Instead or as well, the additional throttle pin(s) may be substantially the same as the throttle pin.

According to a sixth aspect of the present invention there is provided an aircraft enclosure inerting system comprising a vortex tube assembly according to the fifth aspect of the invention.

Such a system may be less reliant on, or have no need of, filtration and air drying systems for the reasons given above. Instead or as well, such a system may be more capable of supplying sufficient NEA in the case of a fault without as much need for backup equipment, for the reasons discussed above.

According to a seventh aspect of the present invention there is provided an aircraft comprising an aircraft enclosure inerting system according to the sixth aspect of the invention.

Such an aircraft may be less reliant on, or have no need of, filtration and air drying systems for its enclosure inerting system, and/or may have a more reliable supply of NEA with less need for backup equipment, for one or more of the reasons discussed above.

It will of course be appreciated that features described in relation to one aspect of the present invention may be incorporated into other aspects of the present invention.

### BRIEF DESCRIPTION OF THE DRAWINGS

Embodiments of the present invention will now be described by way of example only with reference to the accompanying schematic drawings of which:

FIG. 1 shows a plan view of an aircraft according to a first embodiment of the invention;

FIG. 2 shows a simplified cross-sectional side view of a vortex tube of an enclosure inerting system of the aircraft of FIG. 1;

FIG. 3 shows a simplified cross-sectional end view of a vortex tube assembly of the aircraft of FIG. 1 which includes the vortex tube of FIG. 2;

FIG. 4 shows a simplified view of a flow path of the vortex tube, with a buildup of dirt or ice therein.

FIG. 5 shows a schematic close-up of part of the vortex tube assembly of FIG. 3, with a throttle pin in a restrictive position;

FIG. 6 shows a schematic close-up of the same part of the vortex tube assembly as FIG. 4, with the throttle pin in a permissive position;

FIG. 7 shows a simplified cross-sectional end view of a vortex tube assembly according to a second embodiment of the invention; and

FIG. 8 shows a flow-chart of a method according to the second embodiment.

### DETAILED DESCRIPTION OF THE PREFERRED EMBODIMENTS

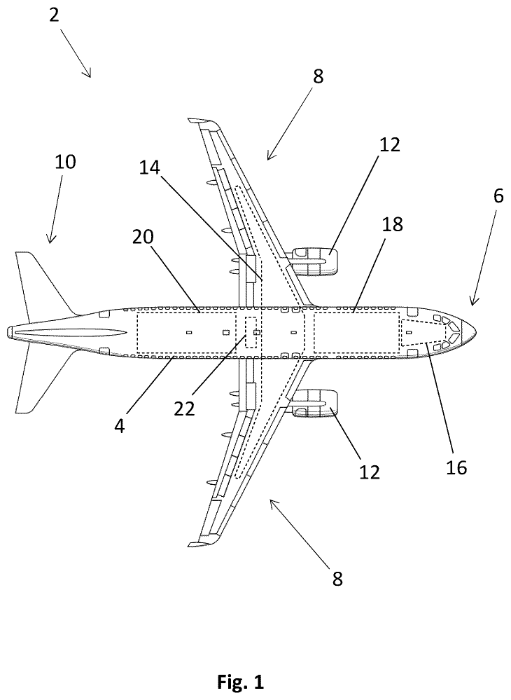

FIG. 1 shows an aircraft 2 according to an embodiment of the invention. It has a fuselage 4 with a nose 6, two wings 8 and a tail 10. Each wing 8 extends from the fuselage 4 in a spanwise direction and supports an engine 12 part way along its spanwise length. An enclosure in the form of a fuel tank 14 extends inside the wings 8 and through the fuselage 4 therebetween. Behind the nose 6, roughly beneath the cockpit, is another enclosure 16 which in this case contains some of the power electronics of the aircraft 2. Also positioned within the fuselage is a cargo bay made up of a fore enclosure 18 and an aft enclosure 20. The aircraft 2 also has an enclosure inerting system 22 which is arranged to provide NEA to each of the enclosures 14, 16, 18, 20 as discussed below.

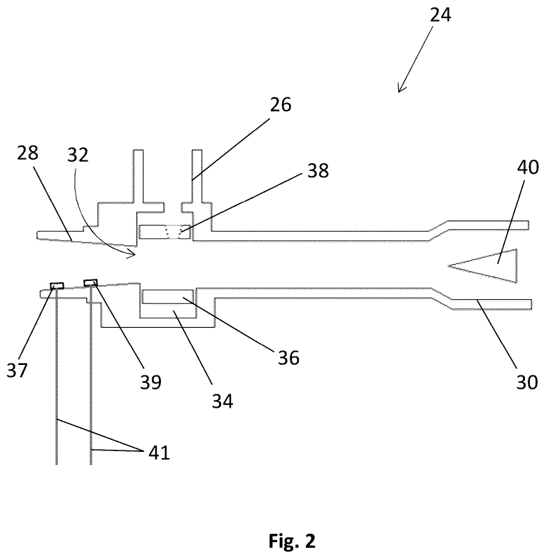

The inerting system 22 receives an inlet air flow from a ram air channel (not visible), then pressurizes it using a compressor (not visible) before cooling it using a heat exchanger (not visible) which brings the temperature of the compressed air down to a manageable level. The inerting system 22 separates the inlet air flow into NEA, which is supplied to the enclosures 14, 16, 18, 20 as needed, and OEA, which is exhausted overboard. This separation of air takes place centrifugally, in a vortex tube of a vortex tube assembly. The vortex tube is shown schematically in FIG. 2, which will now be referred to in combination with FIG. 1.

The vortex tube 24 has an inlet 26, an NEA outlet 28 and an OEA outlet 30. The vortex tube 24 defines a vortex chamber 32 which is circumferentially surrounded by a plenum chamber 34. Positioned inside the plenum chamber 34, and separating the plenum chamber 34 from the vortex chamber 32, is a swirl generator 36. The swirl generator 36 has an inlet passage 38 extending therethrough, which provides fluid communication between the plenum chamber 34 and the vortex chamber 32. In this embodiment the inlet passage 38 takes the form of a tangential inlet which imparts swirl into air flow entering the vortex chamber 32, but in other embodiments the inlet may take a different form, for instance an axial inlet where swirl is imparted by a helical trajectory of the inlet passage 38.

The NEA outlet 28 takes the form of a gradually widening aperture extending away from the vortex chamber 32 in one axial direction. Positioned in the NEA outlet are an oxygen concentration sensor 37 and a flow rate sensor 39 with respective leads 41. The OEA outlet 30 takes the form of an annular passageway positioned circumferentially around a conical projection 40 and extending away from the vortex chamber 32 in the opposite axial direction to the NEA outlet 28.

In use, the inlet air flow enters the plenum chamber 34 through the inlet 26. The inlet air flow then enters the vortex chamber 32 tangentially through the inlet passage 38 of the swirl generator 36. The inlet passage 38 narrows towards the vortex chamber 32, which accelerates the air passing through it, and introduces the air into the vortex chamber 32 tangentially so as to impart swirl as mentioned above. As the air swirls within the vortex chamber 32, it separates into an outer vortex travelling helically in one direction (to the right from the perspective of FIG. 2) and an inner vortex travelling in the other direction (to the left from the perspective of FIG. 2), with both vortices rotating in the same direction.

The rotation of the air in the two vortices has the effect of throwing the heavier gasses outwards into the outer vortex, with lighter gasses remaining in (or being displaced into) the inner vortex. With oxygen being heavier than nitrogen, the oxygen tends to be thrown out into the outer vortex while the nitrogen tends to remain in the inner vortex. Accordingly, the inner vortex is made up of NEA and the outer vortex is made up of OEA. NEA in the inner vortex exits the vortex chamber 32 through the NEA outlet 28, whereupon, in this embodiment, it is fed to a storage tank (not shown) of the inerting system 22 for onward distribution to the enclosures 14, 16, 18, 20 as needed. OEA in the outer vortex exits the vortex chamber 32 through the OEA outlet 30, whereupon it is directed towards an exhaust port (not shown) of the inerting system 22 (and of the aircraft as a whole).

Heavier gasses being thrown out from the inner vortex and into the outer vortex also has the effect of expanding the air in the inner vortex and compressing the air in the outer vortex. This has the effect of cooling the NEA in the inner vortex and heating the OEA in the outer vortex.

In this particular embodiment, the position of the conical projection 40 is movable axially so as to vary the cross sectional area of the OEA outlet 30. Changing the cross sectional area of the OEA outlet 30 has the effect of altering the proportion of air which exits through that outlet 30 rather than the NEA outlet 28, which affects the relative sizes of the inner and outer vortices. This, in turn, affects the degree of air separation performed by the vortex tube 24 and the flow rates of OEA and NEA produced. The conical projection 40 thus functions as a calibration valve which is adjusted during production of the inerting system 22, and then adjusted, if necessary, during routine servicing of the aircraft 2.

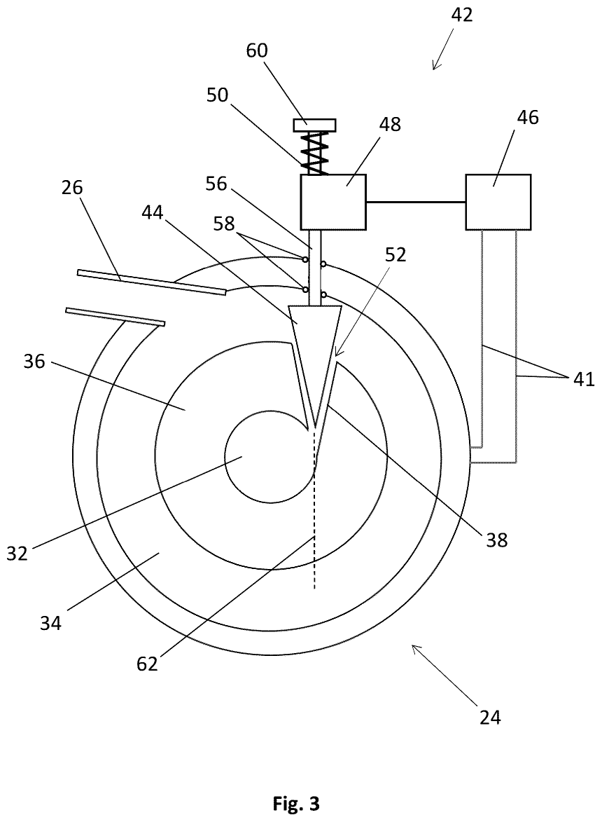

The vortex tube 24 is part of a vortex tube assembly 42. FIG. 3 shows other components of the vortex tube assembly 42 of this embodiment, namely a throttle pin 44, a controller 46, an actuator 48 and a biasing member 50 in the form of a coil spring. FIG. 3 will now be referred to in combination with FIGS. 1 and 2.

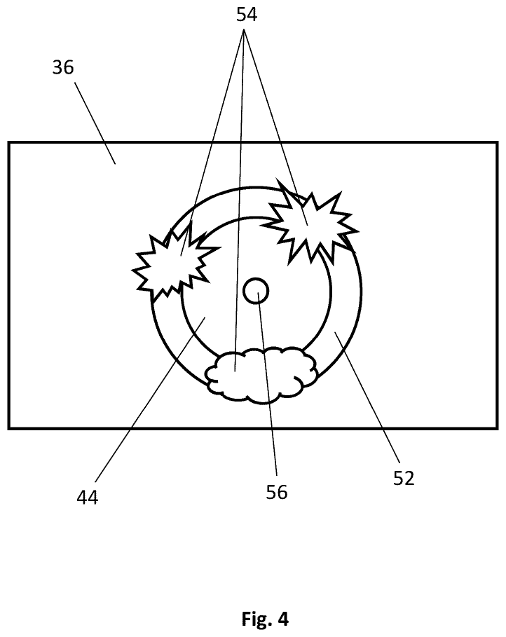

The throttle pin 44 is received within the inlet passage 38 of the swirl generator 36. The outer surface of the throttle pin 44 and the inner surface of the inlet passage 38 co-operatively define a flow path 52 along which air can flow from the plenum chamber 34 into the vortex chamber 32. In the present embodiment the throttle pin 44 and inlet passage 38 both taper towards the vortex chamber 32. More particularly, the throttle pin is substantially conical and the inlet passage 38 is substantially frustoconical. The throttle pin 44 is concentrically positioned within the inlet passage, which gives the flow path 52 an annular cross section, which is shown in FIG. 4. A flow path 52 which is annular in cross section can be less susceptible to being blocked by ice or dirt. As illustrated in FIG. 4, if ice and/or dirt forms agglomerations 54 these may obstruct the flow path 52, but it is less likely that they would join together and completely block the flow path 52 than would be the case if the flow path was non-annular (e.g., circular or square) in cross section.

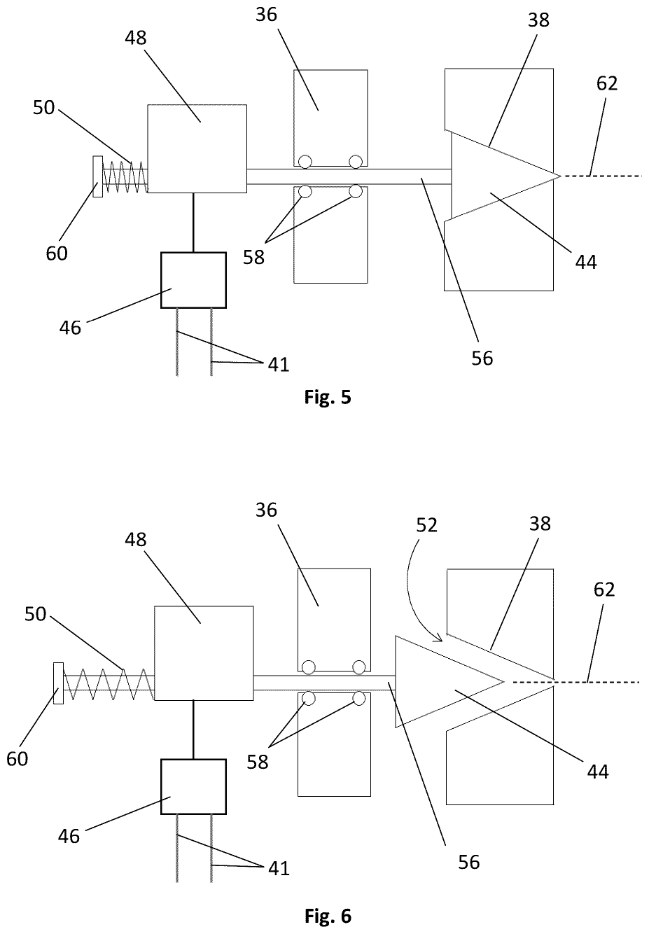

Referring now to FIGS. 1 to 4 in combination, extending rearward from the throttle pin 44 is a control rod 56 which passes through the wall of the plenum chamber 36 (through a pair of O-ring seals 58 which prevent air leakage) and terminates in a flange 60. The control rod 56 is attached to an output shaft (not shown) of actuator 48, which in this embodiment takes the form of an electric linear actuator. The actuator operable by the controller 46 to move the throttle pin 44 between different positions relative to the inlet passage 38. FIG. 5 shows a close-up of the throttle pin 44 in a restrictive position and FIG. 6 shows a close-up of the throttle pin 44 in a permissive position. In FIG. 3, the throttle pin 44 is shown in an intermediate position which is between the restrictive and permissive positions. In fact, in the present embodiment the throttle pin 44 is movable within a continuous range of positions between the restrictive and permissive positions.

Referring now to FIGS. 1 to 6 in combination, when the throttle pin 44 is in the restrictive position, the flow path 52 is more constricted than when the throttle pin is in the permissive position. When the throttle pin 44 is in the intermediate position, the flow path 52 is less constricted than when the throttle pin 44 is in the restrictive position, but more constricted than when the throttle pin 44 is in the permissive position. With the flow path 52 being more or less constricted depending on the position of the throttle pin 44, the speed of air flowing through the flow path 52 into the vortex chamber 32 can be adjusted by adjusting the position of the throttle pin. The swirl of air within the vortex chamber 32, and thus the separation performance of the vortex tube 24, depends (partly) on the speed of the air entering it. Accordingly, the separation performance of the vortex tube 24 can be adjusted by adjusting the position of the throttle pin 44.

It is noteworthy that in this embodiment the throttle pin 44 is movable along the longitudinal axis 62 of the inlet passage 38. Accordingly, as the throttle pin 44 moves the cross sectional shape of the flow path 52 changes evenly about its circumference and air flow is beneficially even about its circumference regardless of the position of throttle pin. That being said, as shown in FIG. 6 when the throttle pin 44 is in the permissive position (or an intermediate position near to the permissive position) only the rear part of the flow path 52 (i.e., the part nearer the plenum chamber 34) is annular in cross section. In those throttle pin positions, the front part of the flow path 52 (i.e., the part nearer the vortex chamber 32) is circular in cross section.

It is also noteworthy that with the throttle pin 44 in the restrictive position, the flow path 52 is substantially closed, meaning that substantially no air can enter the vortex chamber 32 and substantially no air can exit the vortex tube 24 via the NEA outlet 28 or OEA outlet 30. Accordingly, by moving the throttle pin 44 to the restrictive position (using the actuator 48), the controller 46 can place the vortex tube 24 into a deactivated or “switched off” mode.

The controller 46 can also move the throttle pin 44 to place the vortex tube assembly into other discrete modes aside from the deactivated mode, namely a high purity mode, a high flow mode and an intermediate mode. The controller 46 is configured to place the vortex tube assembly 42 in the high purity mode by moving the throttle pin 44 to an intermediate position which is close to the restrictive position. This narrows the flow path 52 so that relatively little air enters the vortex tube but is accelerated to high speed to form a fast vortex, which leads the vortex tube 24 to produce very pure NEA at a low flow rate.

The controller 46 is configured to place the vortex tube assembly 42 in the high flow mode by moving the throttle pin 44 to the permissive position. This widens the flow path 52 to maximize the amount of air entering vortex chamber 32, but the air is accelerated less, resulting in a slower vortex and less separation. Accordingly, in this mode the NEA is produced at a high flow rate but with lower purity.

The controller 46 is configured to place the vortex tube assembly 42 in the intermediate mode by moving the throttle pin 44 to an intermediate position which lies between the permissive position and the intermediate position in which the throttle pin 44 is placed when the vortex tube assembly 42 is in the high purity mode. In this mode the flow path 52 is more constricted than when the vortex tube assembly 42 is in the high purity mode, but less constricted than when the vortex tube assembly 42 is in the high flow mode. Accordingly, an intermediate flow rate of air enters the vortex chamber 32 and the vortex has an intermediate speed, resulting in an intermediate flow rate of NEA being produced at an intermediate level of purity.

The controller 46 is also configured to move the throttle pin a small amount while the vortex tube assembly 42 is in the high purity mode, and while the vortex tube assembly 42 is in the intermediate mode. The controller 46 is connected to the oxygen concentration sensor 37 and flow rate sensor 39 in the NEA outlet 28 of the vortex tube 24, each of which is connected to the controller 46 and able to send signals thereto. The controller 46 is configured to use feedback from these sensors 37, 39 to make minor adjustments to the position of the throttle pin 44, so as to adaptively maintain the oxygen concentration or the flow rate (depending on which parameter is more critical at that moment) at a target level. For sake of an example, if the controller 46 is maintaining oxygen concentration at a particular level while the vortex tube assembly 42 is in the high purity mode, in the event of the oxygen sensor 37 signaling the controller 46 that the oxygen concentration has risen a little, the controller 46 is configured to move the throttle pin 44 to a position in which the flow path 52 is slightly more constricted. This has the effect of increasing the speed of the vortex in the vortex chamber 32 and increasing the purity of the NEA. When the oxygen concentration of the NEA reaches the desired level, the controller 46 stops moving the throttle pin 44 (until such a time as the oxygen concentration deviates from the target value again).

The controller 46 is also configured to move the throttle pin 44 in order to clear obstructions in the flow path 52. More particularly, the controller 46 monitors the signals received from the flow rate sensor 39 and the oxygen concentration sensor 37 via their respective leads 41. If these signals indicate that the flow path 52 is obstructed, for instance if the flow rate goes down but the oxygen concentration goes up, the controller moves the throttle pin 44 to the permissive position and back (unless it is already in the permissive position) over a time of around five seconds in total. This temporarily widens the flow path 52 (i.e., makes it less constricted) so as to allow the obstruction to pass through it, whereupon it is separated into the OEA flow inside the vortex chamber 32 before being exhausted with the OEA through the OEA outlet 30.

Returning to the coil spring 50, the function of this component is to bias the throttle pin 44 to the permissive position. It is coiled around the control rod 56 and held compressed between the flange 60 and the body of the actuator 48. The restorative force from the coil spring 50 acts to urge the flange 60 away from the actuator 48, which urges the throttle pin 44 to the permissive position. Accordingly, for the actuator 48 to move the throttle pin 44 to the restrictive position (or an intermediate position) it must overcome the bias provided by the coil spring 50.

With the throttle pin 44 biased to the permissive position, in the event of a fault (for instance lack of power to the actuator 48 or detachment of the control rod 56 from the actuator 48) the throttle pin 44 can move to the permissive position under action of the coil spring 50, thereby ensuring that sufficient air can enter the vortex chamber 32 and the enclosure inerting system 22 can continue to operate (albeit perhaps supplying NEA at lower purity than would be preferable).

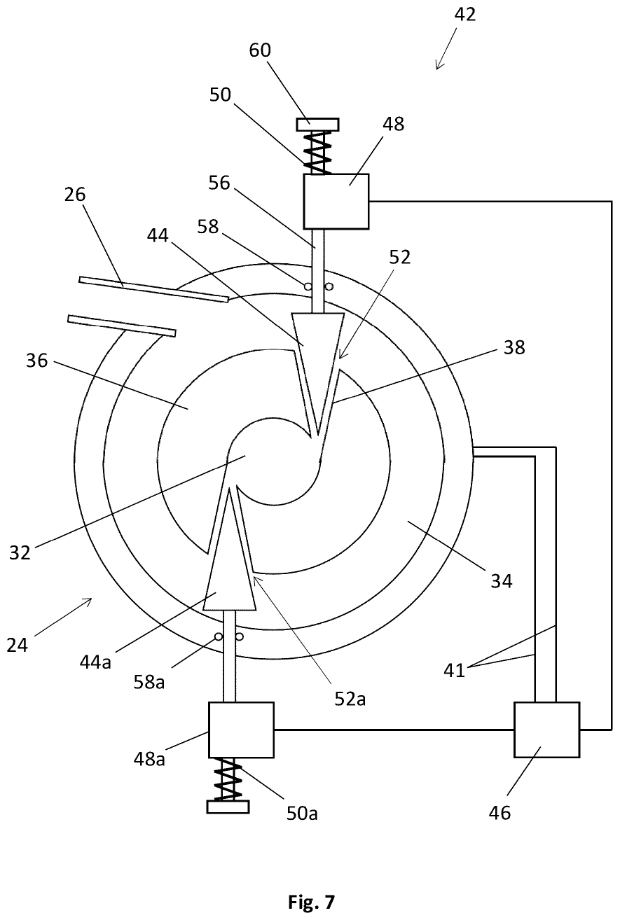

A vortex tube assembly of an aircraft according to a second embodiment of the invention will now be described with reference to FIG. 7, in which corresponding features are denoted by corresponding reference numerals, in combination with FIGS. 1 to 6. The aircraft of second embodiment is similar to that of the first embodiment therefore only the differences will be described here. The differences relate to the vortex tube assembly 42 of the second embodiment.

Whereas in the vortex tube assembly 42 of the first embodiment, all the air entering the vortex chamber 32 passed through a single inlet passage 38, in the second embodiment the vortex tube 24 has an inlet passage 38 and an additional inlet passage 38a, both of which allow air to enter the vortex chamber 32 from the plenum chamber 34. In the present case the additional inlet passage 38a is substantially the same in structure and function, with the exception that its position is diametrically opposed to that of the inlet passage 38.

Just as the inlet passage 38 has a throttle pin 44 received therein, the additional inlet passage 38a has an additional throttle pin 44a positioned therein. The structure and function of the additional throttle pin 44a is the same as that of the throttle pin 44. In particular, the outer surface of the additional throttle pin 44a and the inner surface of the additional inlet passage 38a co-operatively define an additional flow path 52a. Similarly, the additional throttle pin 44a is movable between corresponding positions to the throttle pin 44, under action of an additional actuator 48a, and is biased to its permissive position by an additional biasing member 50a.

In the present embodiment both actuators 48, 48a are connected to a common controller 46. The controller 46 is configured to move both throttle pins 44, 44a between corresponding positions, using their respective actuators 48, 48a, at the same time as one another. Accordingly, where in the first embodiment the controller 46 is configured to move the throttle pin 44 between positions, in the second embodiment the controller 46 is configured to move both throttle pins 44, 44a between corresponding positions, in the same circumstances (e.g., when switching between discrete modes, adaptively maintaining purity or flow rate of NEA, or clearing a blockage in one or both flow paths 52, 52a).

With both throttle pins 50, 50a biased to their respective permissive positions, one or both can enter a failsafe mode if a fault occurs. For example, both may move to the permissive position in the event of a loss of power to the enclosure inerting system 22 as a whole, or either one can move to its permissive position if it becomes detached from the associated actuator 48, 48a.

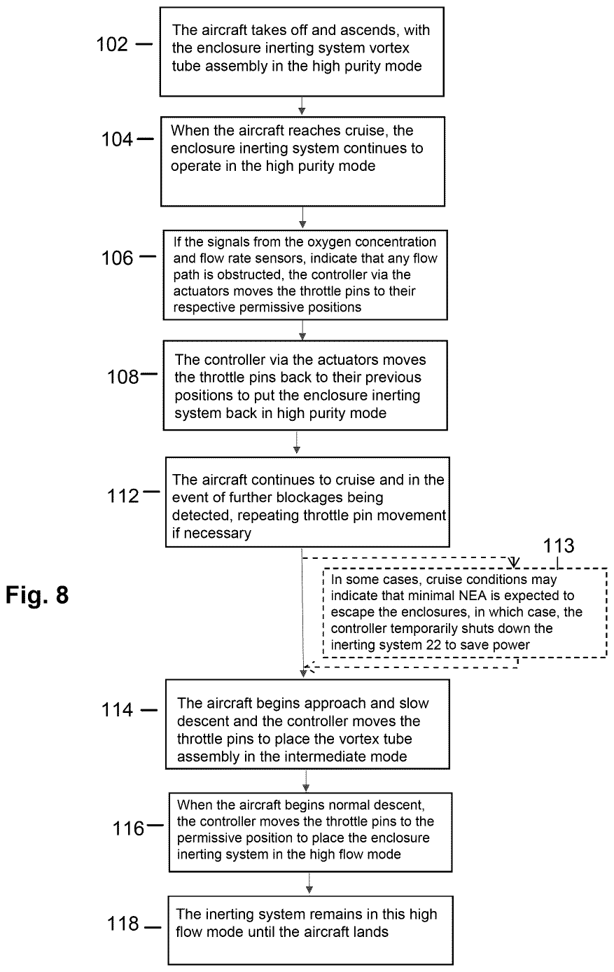

A method of use of the aircraft of the second embodiment will now be described with reference to FIG. 8 along with continued reference to FIGS. 1 to 7.

In a first step 102 the aircraft 2 takes off and ascends, with the enclosure inerting system 22 (more specifically the vortex tube assembly 42) in the high purity mode. Just prior to takeoff, if the enclosure inerting system 22 is not already in that mode the controller 46 operates the actuators 48, 48a to move the throttle pins 44, 44a to the appropriate positions (intermediate positions which are close to the respective restrictive positions, as discussed above).

During takeoff and ascent, the controller 46 monitors the signal received from the oxygen concentration and flow rate sensors 37, 39, making minor adjustments to the positions of the throttle pins 44, 44a so as to adaptively maintain the purity of the NEA flow at the required high level, as discussed above.

When the aircraft 2 reaches cruise 104, the enclosure inerting system 22 continues to operate in the high purity mode, with the controller 46 continuing to adaptively maintain the oxygen concentration at the required level.

In step 106 if the signals from the oxygen concentration and flow rate sensors 37, 39 indicate that the flow path 52 and/or additional flow path 52a is obstructed, the controller 46 responds by using the actuators 48, 48a to move the throttle pins 44, 44a to their respective permissive positions. This widens the flow paths 52, 52a so as to allow the obstruction(s) to clear.

In step 108 the controller 46 then uses the actuators 48, 48a to move the throttle pins 44, 44a back to their previous positions so as to put the enclosure inerting system 22 back in the high purity mode. In the present embodiment the throttle pins 44, 44a are moved to their permissive positions and back over a time of around 5 seconds in total, limiting the effect that their movement has on the purity of NEA produced.

The aircraft then continues to cruise 112. In the event of further blockages being detected, the above procedure may be repeated. In some cases, the aircraft 2 may cruise in conditions in which minimal NEA is expected to escape the enclosures 14, 16, 18, 20, for instance the temperature of the air may be low and there may be minimal change in air pressure (for instance due to minimal change in altitude). In these cases, the controller 48 temporarily shuts down 113 the inerting system 22 so as to save power.

In step 114 the aircraft 2 begins approach and slow descent. At this point the controller 46 moves the throttle pins 44, 44a to place the vortex tube assembly 42 in the intermediate mode. While in this mode, the controller 46 makes minor adjustments to the positions of the throttle pins 44, 44a so as to adaptively maintain the flow rate of NEA at the required level. Also, if the controller 46 detects a blocked flow path 52, 52a then it moves the throttle pins 44, 44a to their permissive positions and back so as to clear the blockage(s) in the same manner as described above.

When the aircraft begins normal descent 116, the controller 46 moves the throttle pins 44, 44a to the permissive position so as to place the enclosure inerting system 22 in the high flow mode. The controller 46 then keeps the throttle pins 44, 44a in this mode rather than performing any blockage clearance or adaptive maintenance of any particular purity or flow rate of NEA. The inerting system 22 remains in this mode until the aircraft 2 lands 118.

The systems and devices described herein may include a controller, such as controller 46, control unit, control device, controlling means, system control, processor, computing unit or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents.

It will also be appreciated by the reader that integers or features of the invention that are described as preferable, advantageous, convenient or the like are optional and do not limit the scope of the independent claims. Moreover, it is to be understood that such optional integers or features, while of possible benefit in some embodiments of the invention, may not be desirable, and may therefore be absent, in other embodiments.

For the avoidance of doubt, while in the above embodiments the permissive and restrictive positions of the throttle pin are the two limits of its range of motion, this should not be construed as limiting. In other embodiments the throttle pin may be able to move beyond the permissive position (perhaps making the flow path even less constricted) and/or may be able to move beyond the restrictive position (perhaps making the flow path even more constricted, for instance substantially preventing flow therethrough as discussed above).

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. A vortex tube assembly for centrifugally separating an inlet air flow into a nitrogen-enriched air (NEA) flow and an oxygen-enriched air (OEA) flow in an aircraft enclosure inerting system, the vortex tube assembly comprising:
a plenum chamber configured to receive the inlet air flow;
a vortex chamber configured to provide centrifugal separation of the inlet air flow into the NEA flow and the OEA flow;
a swirl generator having an inlet passage configured to provide fluid communication between the plenum chamber and the vortex chamber; and
a throttle pin positioned within the inlet passage, an outer surface of the throttle pin and an inner surface of the inlet passage co-operatively defining a flow path for air to enter the vortex chamber from the plenum chamber, wherein:
the throttle pin is selectively movable relative to the inlet passage between a restrictive position and a permissive position, the flow path being more constricted when the throttle pin is in the restrictive position than when the throttle pin is in the permissive position; and
the throttle pin is biased to the permissive position and movable to the restrictive position against said bias.

2. The vortex tube assembly according to claim 1 wherein at least part of the flow path is annular in cross section.

3. The vortex tube assembly according to claim 1 wherein the inlet passage extends along a longitudinal axis and the throttle pin is movable along said axis between the restrictive and permissive positions.

4. The vortex tube assembly according to claim 1 wherein at least part of the inlet passage narrows towards the vortex chamber.

5. The vortex tube assembly according to claim 1 wherein at least part of the throttle pin narrows towards the vortex chamber.

6. The vortex tube assembly according to claim 1 wherein the throttle pin is biased to the permissive position by a resilient member.

7. The vortex tube assembly according to claim 1 wherein with the throttle pin has a position in which the flow path is substantially closed.

8. The vortex tube assembly according to claim 1 further comprising a controller and an actuator which is operable by the controller to move the throttle pin between positions.

9. The vortex tube assembly according to claim 8 wherein:
the throttle pin is also movable to one or more intermediate positions, that lie between the restrictive position and the permissive position, in which the flow path is less constricted than when the throttle pin is in the restrictive position but more constricted than when the throttle pin is in the permissive position; and
the controller is configured to move the throttle pin, using the actuator, between two or more positions so as to adjust a performance of the vortex tube assembly.

10. The vortex tube assembly according to claim 9 wherein the controller is configured to move the throttle pin between said two or more positions so as to adaptively maintain an output parameter of the vortex tube assembly at a target level.

11. The vortex tube assembly according to claim 10 wherein said output parameter is an oxygen concentration of the NEA flow or the OEA flow.

12. The vortex tube assembly according to claim 10 wherein said output parameter is a flow rate of the NEA flow or the OEA flow.

13. The vortex tube assembly according to claim 8 wherein the controller is configured to move the throttle pin between positions so as to switch between different discrete modes of the vortex tube assembly.

14. The vortex tube assembly according to claim 13 wherein:
the discrete modes include a first mode and a second mode;
an oxygen concentration of the NEA flow is lower when the vortex tube assembly is in the first mode than when it is in the second mode; and
a flow rate of the NEA flow is lower when the vortex tube assembly is in the first mode than when it is in the second mode.

15. The vortex tube assembly according to claim 8 wherein the controller is configured to receive a signal indicative of the flow path being obstructed, and respond by moving the throttle pin to another position and back to an initial position so as to clear an obstruction.

16. The vortex tube assembly according to claim 1 wherein the swirl generator comprises one or more additional inlet passages, the, or each, additional inlet passage providing fluid communication between the plenum chamber and the vortex chamber.

17. A vortex tube assembly according to claim 16 wherein:
each additional inlet passage has a corresponding additional throttle pin positioned within it, an outer surface of the additional throttle pin and an inner surface of the additional inlet passage co-operatively defining an additional flow path for air to enter the vortex chamber from the plenum chamber; and
each additional throttle pin is selectively movable relative to a corresponding additional inlet passage between a restrictive position and a permissive position, the corresponding additional flow path being more constricted when said additional throttle pin is in the restrictive position than when said additional throttle pin is in the permissive position.

18. The vortex tube assembly according to claim 17 wherein each additional throttle pin is biased to the permissive position and movable to the restrictive position against said bias.

19. An aircraft enclosure inerting system comprising a vortex tube assembly according to claim 1.

20. A method of controlling separation of an inlet air flow into a nitrogen-enriched air (NEA) flow and an oxygen-enriched air (OEA) flow using a vortex tube assembly which comprises:
a plenum chamber configured to receive the inlet air flow;
a vortex chamber configured to centrifugally separate the inlet air flow into the NEA flow and the OEA flow;
a swirl generator having an inlet passage which provides fluid communication between the plenum chamber and the vortex chamber; and
a throttle pin positioned within the inlet passage, an outer surface of the throttle pin and an inner surface of the inlet passage co-operatively defining a flow path for air to enter the vortex chamber from the plenum chamber,
wherein the throttle pin is selectively movable relative to the inlet passage between a restrictive position and a permissive position, said flow path being more constricted when the throttle pin is in the restrictive position than when the throttle pin is in the permissive position,
wherein the method comprises:
operating the vortex tube assembly with the throttle pin in one of said positions; then
in response to a signal indicative of the flow path being obstructed, moving the throttle pin to the other of said positions and then back so as to clear an obstruction; and
then continuing operation of the vortex tube assembly with the throttle pin in said one of said positions.
